(19) United States
(12) Patent Application Publication
(10) Pub. No.: US 2010/0039006 A1
(43) Pub. Date: Feb. 18, 2010

(54) Shielded Theft-Resistant Display Case

(75) Inventors: Doug Lawrence, Fond Du Lac, WI (US); Shawn McHugh, Menomonee Falls, WI (US); Jeff Luetschwager, Hubertus, WI (US); Mike Sellhausen, Sussex, WI (US)

Correspondence Address: JANSSON SHUPE & MUNGER LTD., 245 MAIN STREET, RACINE, WI, 53403, US

(73) Assignee: T.J. HALE CO., Menomonee Falls, WI (US)

(21) Appl. No.: 12/543,324

(22) Filed: Aug. 18, 2009

Related U.S. Application Data
(60) Provisional application No. 61/089,780, filed on Aug. 18, 2008.

(51) Int. Cl. A47F 3/00; E05B 65/00

(52) U.S. Cl. 312/128; 70/57

(57) ABSTRACT

A shielded theft-resistant display case for displaying valuable merchandise during normal business hours and for shielding such merchandise out of view and storing such valuable merchandise in a secure and locked condition after business hours. The shielded theft-resistant display case includes a transparent top, a front panel, a pair of side panels, and a display shelf attached to the panels below the transparent top. A shield is pivotally mounted within the display case to cover and secure the display shelf. The shield is selectively pivotable into a first position in the housing such that items supported on the display shelf are displayed in the upper section of the housing. The shield is selectively pivotable into a second position in the housing such that items supported on the display shelf are hidden from view and fully secured with the display case.

### RELATED APPLICATION

This application claims the benefit of U.S. Provisional Application No. 61/089,780, filed Aug. 18, 2008, the entire contents of which are incorporated herein by reference.

### FIELD OF THE INVENTION

This invention relates to theft-resistant display cases and more particularly to a case for displaying valuable merchandise during normal business hours, and for shielding such merchandise out of view and storing such valuable merchandise in a locked condition after business hours.

### BACKGROUND OF THE INVENTION

Even with the use of sophisticated security systems, merchants have experienced a rise in the theft of their merchandise over the years. This is particularly true in the jewelry, watch and coin businesses. Although security alarm systems indicate the presence of an intruder, the lapse of time between the activation of the alarm and the arrival of the police leaves the intruder with several minutes to break the glass tops of display cases, grab the merchandise and escape before the police arrive. Such burglaries are a serious problem for retailers who display precious merchandise such as jewelry, watches or coins and the like. Many retailers leave a significant amount of their merchandise in display cases overnight, due to limited vault space or the time consuming task of transferal. In such after hours situations, the upper glass portion of the case may be easily broken and the merchandise stolen—in many cases, within several minutes.

Accordingly it would be beneficial to provide a cost effective theft-resistant display case which is simple to operate and includes a shield that can be stored out of sight when displaying merchandise during business hours. In addition, it would be beneficial to provide a theft-resistant display case having a shield that will completely cover and obscure displayed merchandise when the shield is in place and the case locked to secure the merchandise. Furthermore it would be beneficial to provide a theft-resistant display case with a security shield that includes a one piece durable cover to obscure and protect displayed merchandise and to deter theft while avoiding the necessity of emptying the display case each evening.

Therefore, it is an object of our invention to provide a theft-resistant display case with a lockable security shield for deterring burglary and protecting the merchandise inside the case from theft.

A further object of our invention is to provide a theft-resistant display case with a security shield having simple construction that is easy to use, requires minimal maintenance and is affordable to retailers and wholesalers.

A further object of our invention is to provide a theft-resistant display case with a security shield which securely holds and selectively hides valuable merchandise within the case, both during and after business hours so that the case does not have to be emptied and refilled on a daily basis.

Another object is to provide a theft-resistant display case with a security shield having a locking mechanism conveniently located for authorized personnel to operate and which is difficult for thieves to defeat.

A further object of our invention is to provide a theft-resistant display case with a security shield which stores completely out of sight when not in use thereby enhancing the aesthetic appearance of the display case.

A still further object of our invention is to provide a theft-resistant display case with a security shield which is resistant to intrusion with blunt or heavy objects such as hammers or weights.

It is also an object of the present invention to provide a theft-resistant display case with a mechanism to allow easy and effortless movement of the security shield to one of two operable positions allowing the case to be used in a showroom environment during business hours while providing the security necessary to hold valuable merchandise overnight and to deter theft.

### SUMMARY OF THE INVENTION

A theft-resistant display case includes a housing that provides a display section, a display shelf and an exterior wall that is at least partly transparent. The theft-resistant display case includes a semi-circular shield movably mounted within the housing for covering the display shelf. Means for selectively moving the semi-circular shield into a first position in the housing are included where items supported on the display shelf are displayed in view in the upper section of the housing. Means for moving the semi-circular shield into a second position in the housing are also included which cover the display shelf so that the semi-circular shield is hidden from view. The semi-circular shield may be one piece formed from a variety of materials including steel, titanium and the like. The semi-circular shield is pivotable from a first position into a second position for ease of use.

In another embodiment, the display case includes a transparent top, a front panel, a pair of side panels, and a display shelf attached to the panels below the transparent top. A shield is pivotally mounted within the display case to cover and secure the display shelf. Means are included for selectively pivoting the shield into a first position such that items supported on the display shelf are displayed in the upper section of the housing. Means are included for moving the shield into a second position such that items supported on the display shelf are hidden from view.

### BRIEF DESCRIPTION OF THE DRAWINGS

FIG. 1 is a front side cut away perspective view of the theft-resistant display case of the present invention illustrating the security shield mounted in a stored position to display merchandise;

FIG. 2 is a rear side cut away perspective view of the display case of FIG. 1 illustrating the security shield in transit from a stored position to a position in which the displayed merchandise will be hidden from view;

FIG. 3 is a front side cut away perspective view of the display case of FIG. 1 with the security shield in position where the display shelf is hidden from view and secured;

FIG. 4 is a front side perspective view of the display case showing the steel reinforcement of the case;

FIG. 5 is a rear side perspective view of the display case showing the drawers and lock mechanism;

FIG. 6 is rear side perspective view of the display case with the end and rear panels removed showing the security shield positioned to hide the display shelf from view;

FIG. 7 is rear side perspective view of the display case with the end panel, rear panel and drawers removed showing the security shield lock mechanism;

FIG. 8 is a rear perspective view of the security shield in the open position with a retractable handle assembly in the stowed position within the display case;

FIG. 9 is a rear perspective view of the security shield of FIG. 8 with the retractable handle in use for moving the security shield;

FIG. 10 is a rear perspective view of the security shield of FIG. 8 in the closed position with the retractable handle assembly folded against the display case;

FIG. 11 is a rear perspective view of the security shield in the open position with a telescopic handle assembly in the stowed position within the display case;

FIG. 12 is a rear perspective view of the security shield of FIG. 11 with the telescopic handle assembly in the expanded position ready for use to move the security shield;

FIG. 13 is a rear perspective view of the security shield of FIG. 11 in the closed position with the telescopic handle assembly shown expanded for use;

FIG. 14 is a rear perspective view of the security shield of FIG. 11 in the closed position with the telescopic handle assembly shown compressed for storage;

FIG. 15 is a side view of the security shield in the closed position with a foot pedal assembly used to control the position of the security shield; and

FIG. 16 is a side view of the security shield of FIG. 15 showing the foot pedal assembly opening the security shield.

### DESCRIPTION OF THE PREFERRED EMBODIMENT

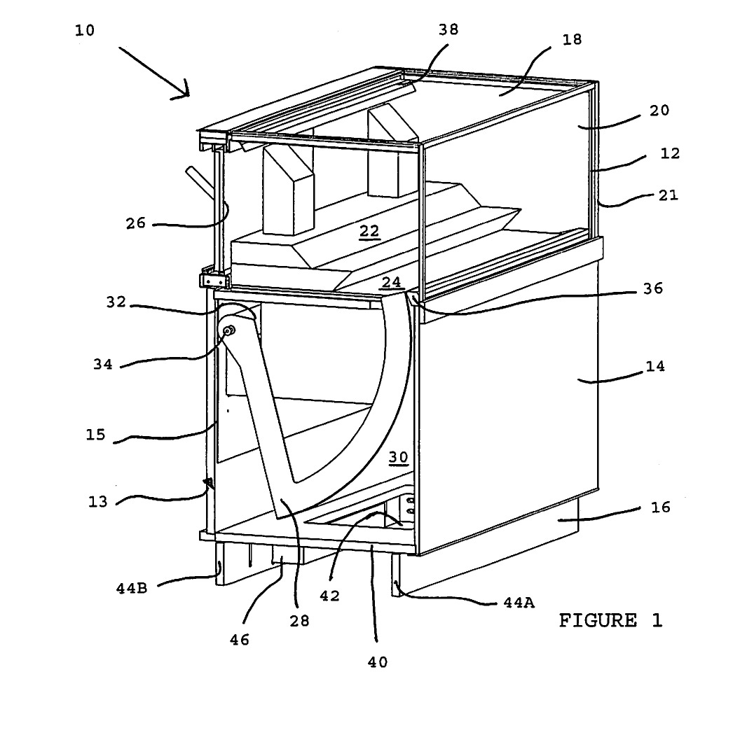

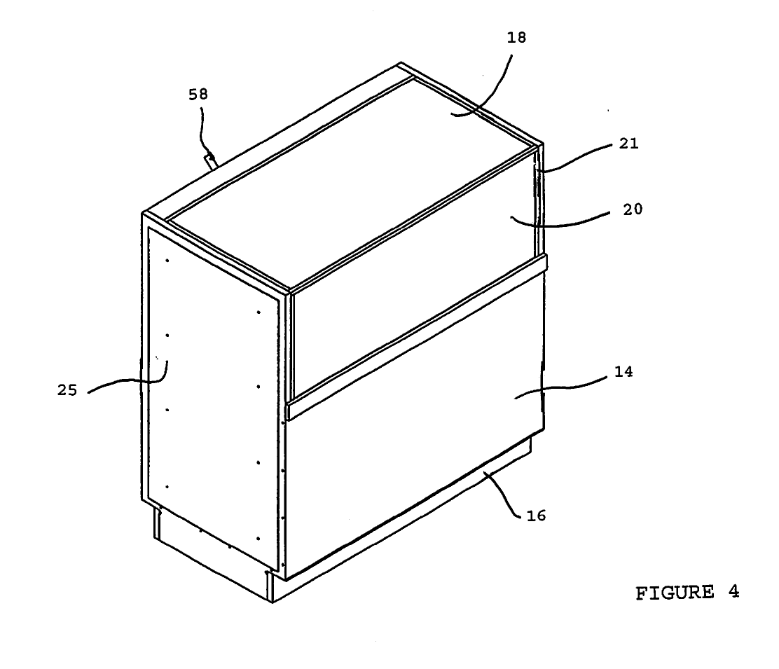

Referring now to the drawings and to FIG. 1 where an embodiment of the shielded theft-resistant display case of the present invention is shown generally as case 10. The structure includes side panels 12 and rear panel 13, usually of solid wood and reinforced by complementary steel panels such as steel rear panel 15 (See also FIG. 4), supporting the ends of the case. Front panel 14, including a steel front panel (not shown), is configured with a recessed toe kick 16 so customers may stand proximate to case 10 and over transparent top 18 and transparent front 20 while viewing display tray 22 on which merchandise is displayed. It is also contemplated that side panels 12 may be constructed from glass as required by particular design specifications. As disclosed herein, a glass panel may include but is not limited to safety glass, laminated glass, tempered glass and the like. Display tray 22 is removable and is supported by display shelf 24 which may be covered in a variety of materials to provide a show room finish to the interior of case 10. As shown in FIG. 1, doors 26 slide open across the back of the case 10 to provide access to display tray 22 and the displayed merchandise. Although the display case has a generally rectangular cross sectional shape, it should be understood that various alternative shapes may be employed in various size ranges. It may also be appreciated that a variety of door configurations may be used and are contemplated herein. Such door designs may include hinged doors, pivotable doors, slidable doors and the like.

FIG. 1 further illustrates case 10 with security shield 28 which comprises solid semi-circular member 30 shown in the retracted position wherein the display tray 22 is visible through transparent top 18 and transparent front 20 to view the merchandise displayed. Security shield 28 including semi-circular member 30 may be made from a variety of materials which provide the strength and security necessary to properly protect the merchandise positioned on display tray 22. Such materials may include cold rolled steel, formed steel, carbon steel, high strength low alloy (HSLA) steel, stainless steel and the like. Security shield 28 may include open ends as illustrated or may include solid end panels to provide added security to the merchandise when secured in case 10. Configuration of security shield 28 with solid end panels may also eliminate the need for reinforcement of the side panels 12 based on a particular application or security requirements. Such reinforcement may include steel plates, alloy plates, titanium plates and the like. While steel may be referred to herein, it should be understood that such material may include steel, alloy, titanium and the like throughout this specification.

Security shield 28 may also be constructed of light weight material so as to be constructed to look identical to the reinforced material such that all cases in a given show room look identical. A configuration using less expensive and lighter weight material to construct security shield 28 would reduce the cost of outfitting a large show room with cases that look identical so as to confuse or misdirect would be burglars. Light weight construction of security shield 28 may include construction from materials including but not limited to plastic, plastic composites, polyvinyl chloride, Mylar, wood composites and the like.

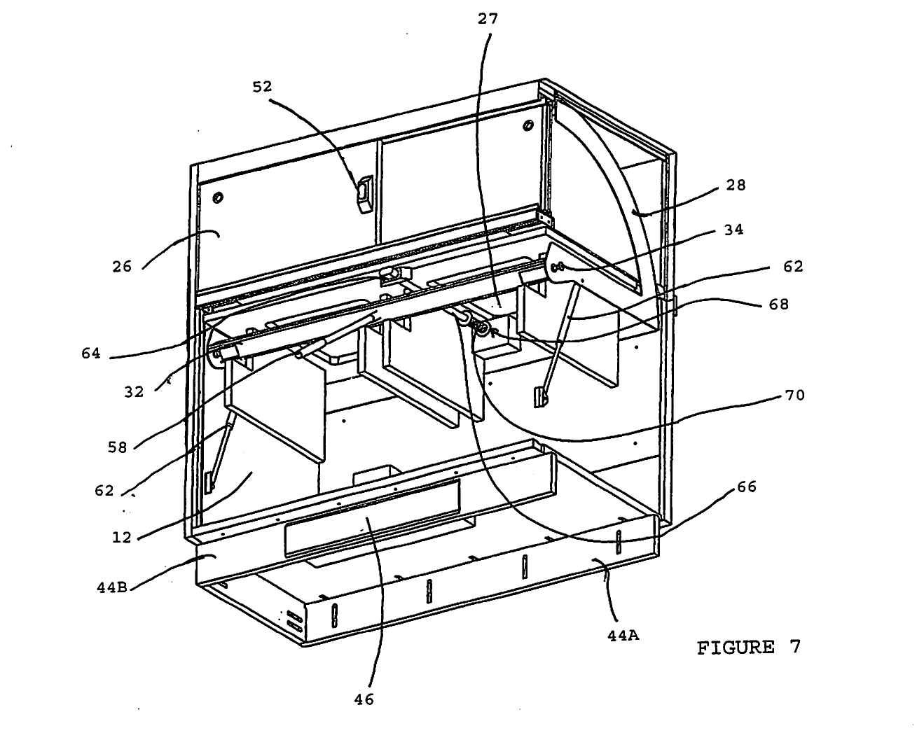

Security shield 28 is attached to shaft 32 and mounted to case 10 at pins 34. Pins 34 form the pivot points for security shield 28 and are positioned through side panels 12 to securely fasten security shield 28 and shaft 32 to case 10. In the retracted position as shown in FIG. 1, security shield 28 is flush with display shelf 24 and positioned behind ledge 36 affixed to the top of front panel 14. This construction provides an aesthetic finish to the front of case 10 commensurate with the quality common in jewelry, watch and coin show rooms. Case 10 includes lighting fixture 38 positioned above display tray 22 and display shelf 24. Lighting fixture 38 provides the necessary lighting to aesthetically and properly display the merchandise on display tray 22. Lighting Fixture 38 may be one of many types of lighting fixtures which may include one or more light bulbs such as incandescent, halogen, light emitting diode, high intensity discharge, fluorescent and the like. Case 10 includes bottom panel 40 with access port 42 and base members 44A, 44B which in conjunction with side panels 12, rear panel 13, front panel 14 and doors 26 properly support and secure the interior components including display shelf 24, display tray 22 and the merchandise displayed thereon. Front panel 14, side panels 12, rear panel 13 and bottom panel 40 may be joined together by an appropriate metal frame 21 or other standard display case structure. To provide the desired security to front panel 14, side panels 12, rear panel 13 and bottom panel 40 steel plates are interposed between the interior of case 10 and the respective panel, as illustrated by steel side panel 25 shown in FIG. 4; steel rear panel 15 shown in FIG. 1 and steel display shelf panel 27 shown in FIG. 7. Corresponding reinforcement panels in a shape complementary to each of side panels 12, front panel 14, rear panel 13, display shelf 24 and bottom panel 40 are not shown individually but are included and contemplated herein as necessary to fully secure and protect merchandise displayed in case 10. Such panels may be constructed from steel, alloy, titanium or similarly impervious material. Doors 26 may be one of a variety of secure designs including high security doors made of steel, high strength alloy, titanium or the like. Base member 44B includes connection box 46 which provides the necessary space for electrical connections, power and the like for operation of case 10.

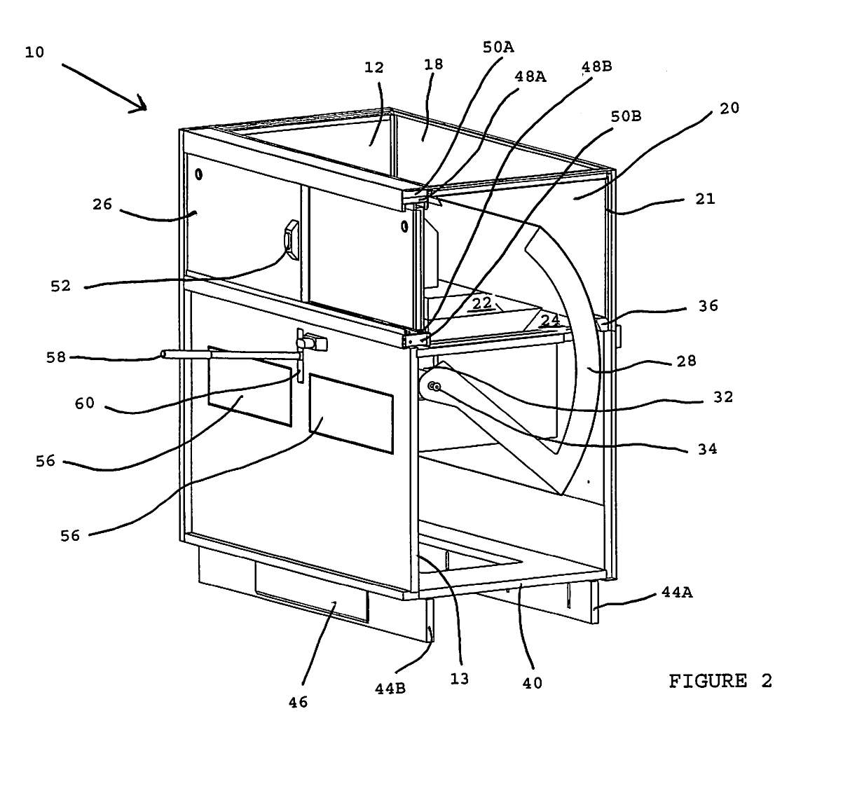

FIG. 2 shows doors 26 which are affixed to case 10 between two U-shaped tracks 48A, 48B. U-shaped tracks 48A, 48B are positioned oppositely in parallel alignment with the U of track 48A positioned downward and the U of track 48B positioned upward. U-shaped tracks 48A, 48B are fastened inside to sash members 50A, 50B by mounting screws positioned through U-shaped tracks 48A, 48B securely enclosing the display tray and merchandise thereon when doors 26 are closed. Lock 52 is positioned on one of the doors 26 to lock the doors in the closed position as illustrated. Lock 52 may include one or more of a plunge lock, barrel lock, rim lock, mortise lock, bored lock or the like. Case 10 may also include one or more drawers 56 positioned below display shelf 24 and accessible from the rear of case 10 through rear panel 13. It may be appreciated that drawers 56 may be configured into a variety of other compartment types based on design requirements including but not limited to shelves and the like.

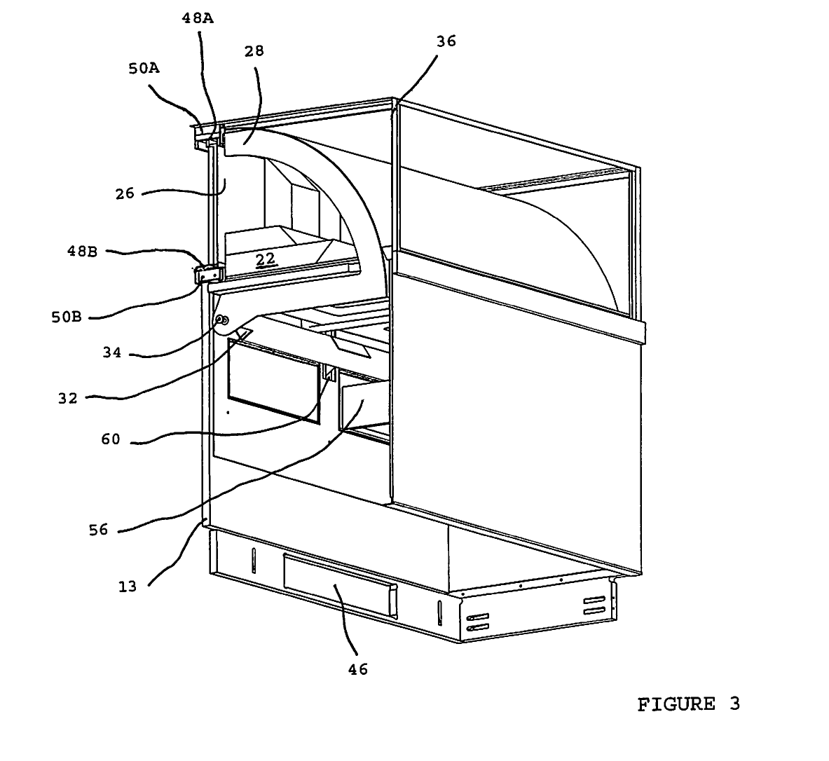

As illustrated in FIGS. 2 and 3 security shield 28 may be moved from its retracted position (shown in FIG. 1) to its secure position fully covering and obscuring display tray 22 and the merchandise displayed thereon (shown in FIG. 3). Such movement is achieved through the positioning of handle 58 which is mounted or otherwise affixed to shaft 32. Handle 58 may be removably attached to shaft 32 through the use of a female receptacle 60 into which handle 58 may be inserted. Alternative connections of handle 58 to shaft 32 may include a variety of link, pin or knuckle configurations which may include a removable or fixed handle arrangement. In addition, an alternative design for movement of shaft 32 may include a cord and reel arrangement or other type of pulley configurations. Handle 58 may be constructed of a variety of materials including but not limit to metal, carbon fiber, aluminum, titanium, wood, plastic and the like. While the position of handle 58 may be described herein as up or down, it should be understood that any position of handle 58 may correspond to any position of security shield 28 depending on the specific design parameters required for a given installation.

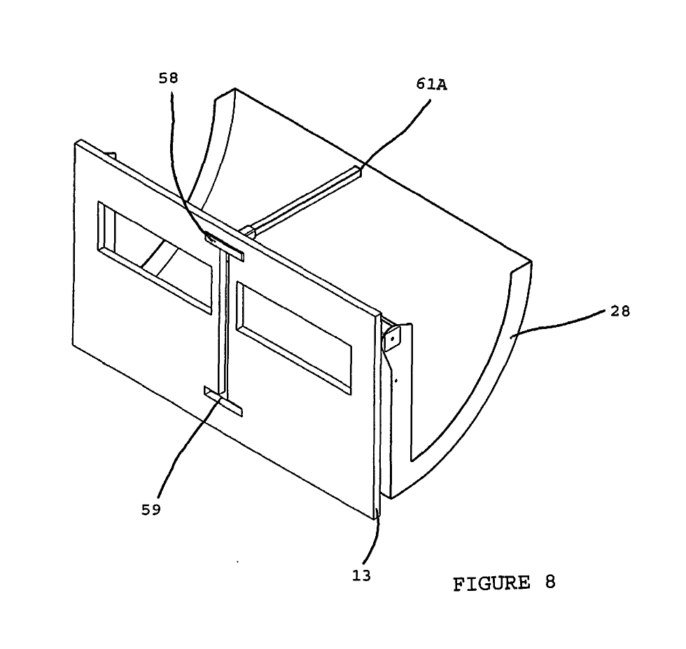

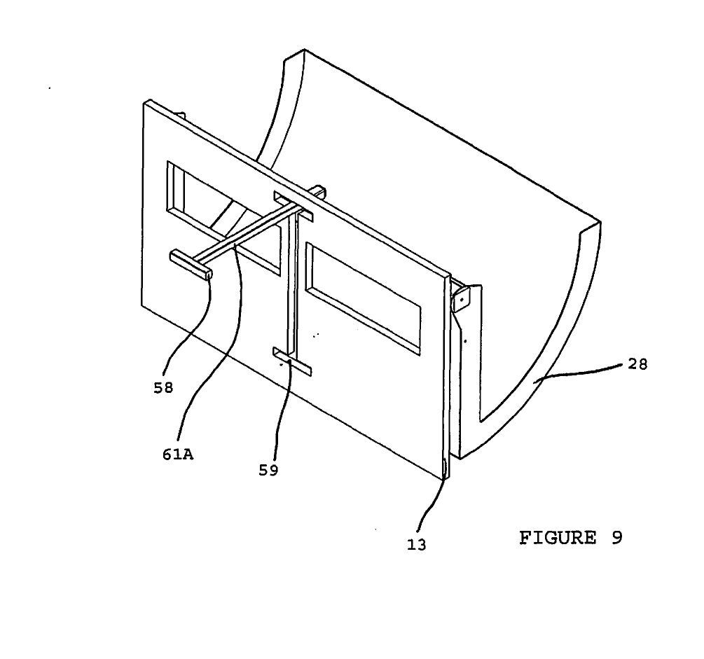

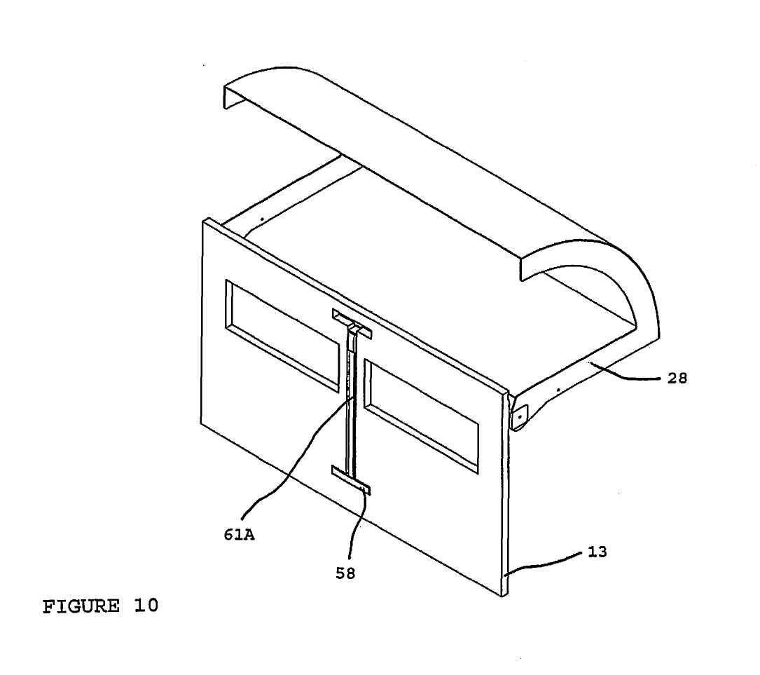

As shown in FIGS. 8, 9 and 10, handle 58 may include a sliding arrangement whereby handle 58 includes a shaft 61 A which retracts into case 10 or folds against rear panel 13. FIG. 8 illustrates shaft 61 A retracted into case 10 through end panel 13 when shield 28 is in the open position such that display shelf 24 and the merchandise thereon is in full view through transparent top 18 and transparent front 20 of case 10. FIG. 9 illustrates handle 58 pulled away from case 10 with shaft 61A pulled through end panel 13 and engaged for use to move security shield 28 from the open position to the closed position. Upon full movement of handle 58 toward end panel 13, shaft 61A engages security shield 28 and as handle 58 is pulled downward towards rear panel 13, security shield 28 is moved into the closed position covering display shelf 24 and the merchandise thereon. After security shield 28 is in the closed position, handle 58 and shaft 61A may be moved into complementary receptacle 59 in end panel 13 for storage flush against end panel 13.

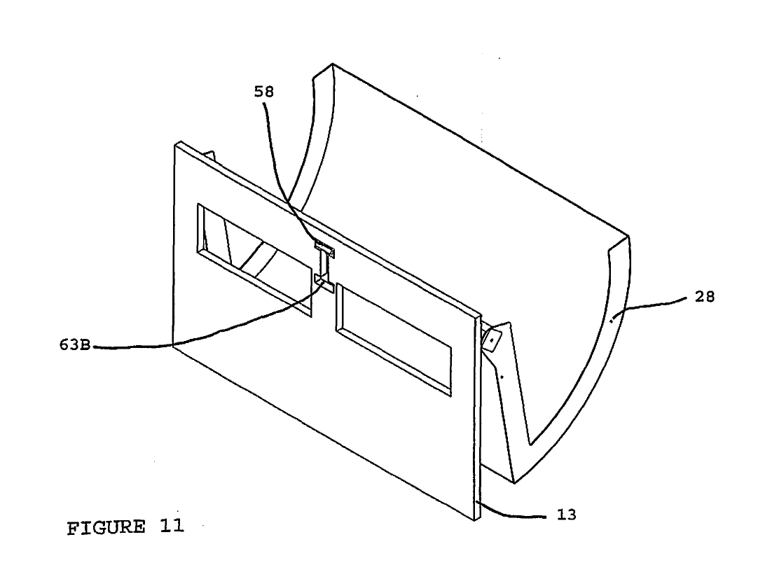

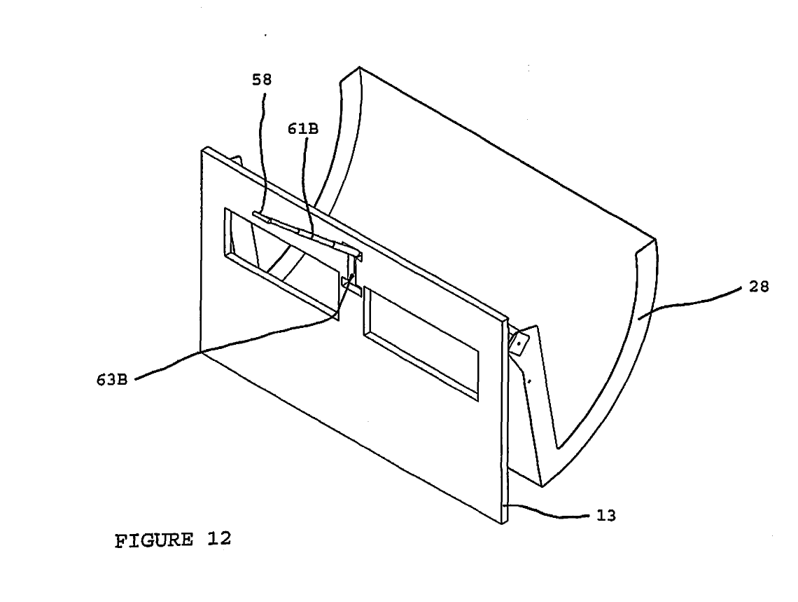

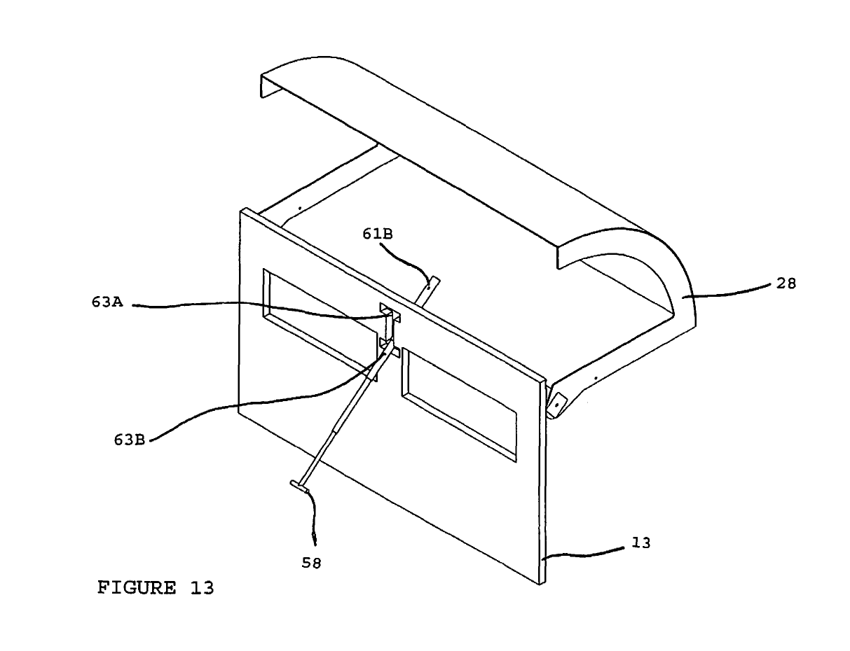

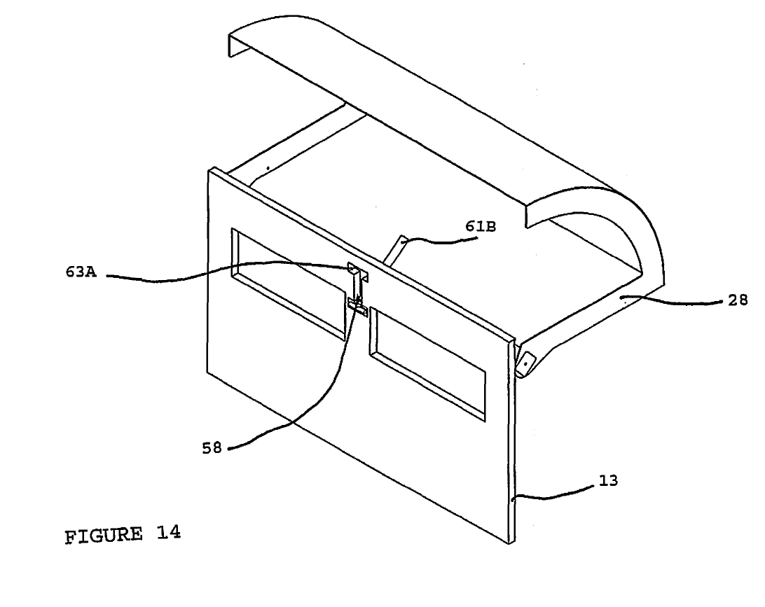

Alternatively, as shown in FIGS. 11, 12, 13 and 14 handle 58 may attach to a telescopic shaft 61B wherein handle 58 collapses into shaft 61B and is positioned within a complementary aperture 63A within rear panel 13 when not being used to move shield 28. As shown in FIG. 11, security shield 28 is in the open position such that display shelf 24 and the merchandise thereon is in full view through transparent top 18 and transparent front 20 of case 10. In FIG. 12, handle 58 is pulled from aperture 63A, expanding telescopic shaft 61B for use in moving security shield 28. As shown in FIG. 13, handle 58 and telescopic shaft 61B are moved downward toward rear panel 13 moving security shield 28 into a closed position covering display shelf 24 and the merchandise thereon. In FIG. 14, handle 58 is pushed inward toward case 10 and telescopic shaft 61B collapses into itself allowing handle 58 to store in a complementary aperture 63B.

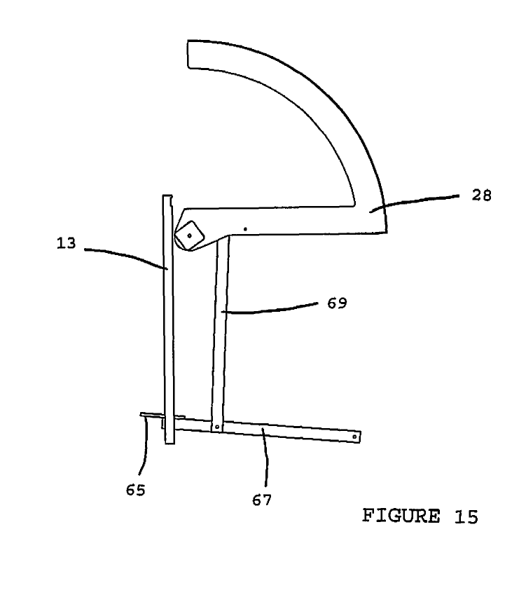

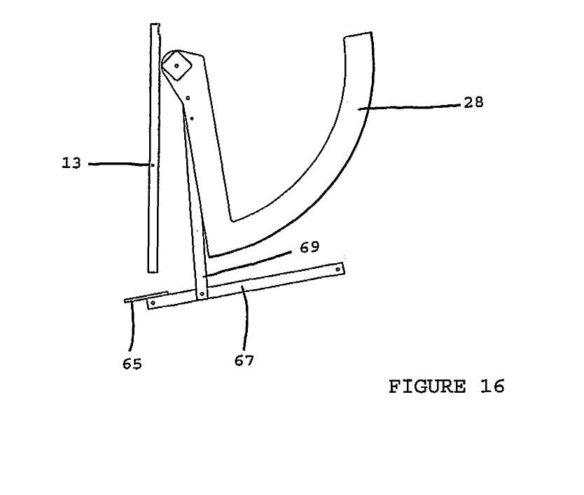

As shown in FIGS. 15 and 16, pedal 65 is attached to member 67 which is positioned through end panel 13 to connect to security shield 28 through link 69. As illustrated in FIG. 15, security shield 28 is in the closed position covering display shelf 24 and the merchandise thereon. Pedal 65 is pressed downward moving member 67 downward and pulling link 69 to open security shield 28 as shown in FIG. 16.

In the open position with pedal 65 pressed downward, security shield 28 is retracted below display shelf 24 such that display shelf 24 and the merchandise thereon is in full view through transparent top 18 and transparent front 20 of case 10. Pedal 65 can then be subsequently lifted to raise security shield 28 back to its closed position covering display shelf 24 and the merchandise thereon.

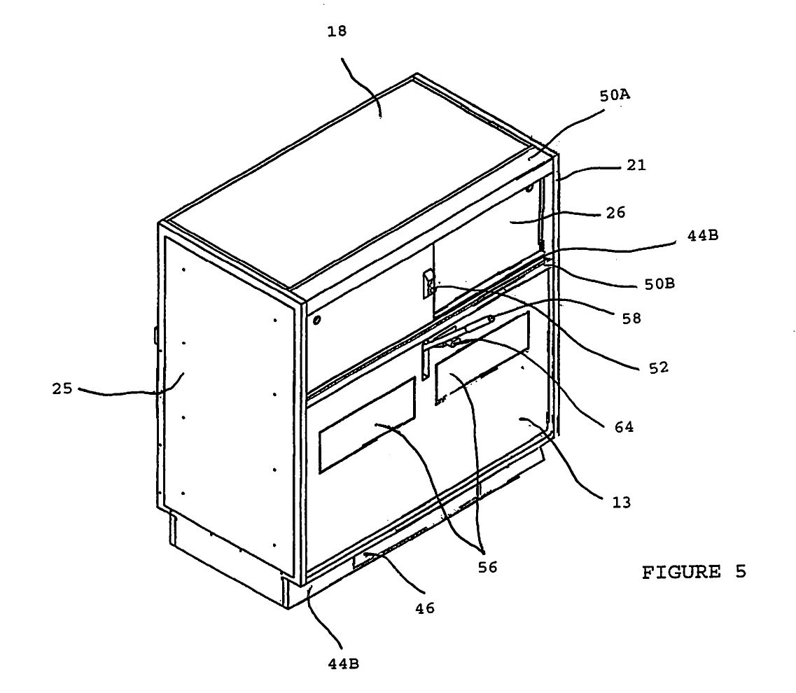

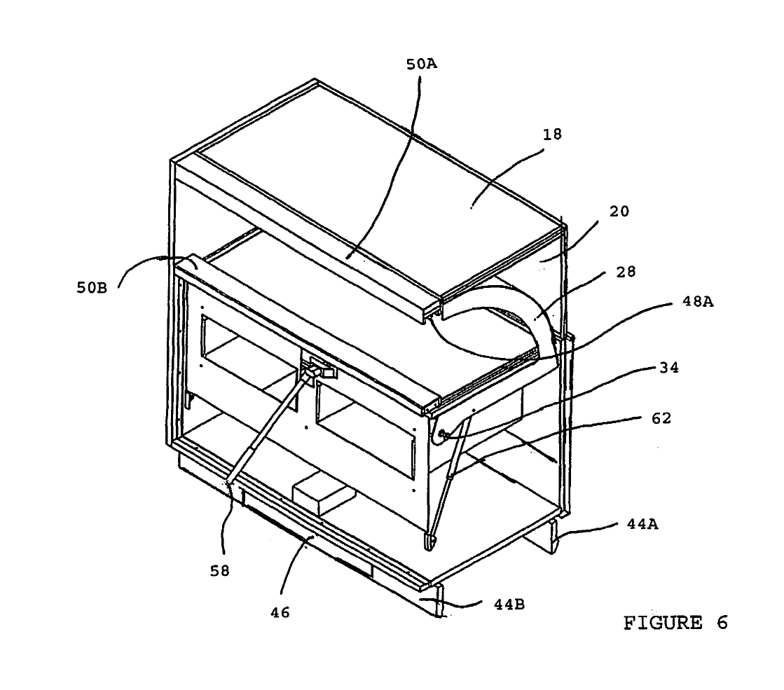

Referring to FIGS. 1-7, when handle 58 is in its full upward position, security shield 28 will be in its fully retracted position as shown in FIGS. 1 and 5. When handle 58 is in its full downward position security shield 28 will be completely covering, obscuring and securing display tray 22 and the merchandise thereon as shown in FIGS. 3, 6 and 7. To provide ease in movement of security shield 28, assists 62 are included as shown in FIGS. 6 and 7. Assists 62 may be one of hydraulic, gas or spring members which provide balance and ease of movement of security shield 28. Assists 62 are attached to rear panel 13 at one end and to security shield 28 the other end to provide smooth, balanced movement of security shield 28 through reduce operating force. Assists 62 allow security shield 28 to be easily moved from an open to closed position or a closed to open position with minimal effort by show room personnel. While assists 62 are shown at one end attached to rear panel 13, it should be understood that such attachment point may be one of side panel 12, rear panel 13 or bottom panel 40 depending on the specific design requirements.

As shown in FIGS. 5, 6 and 7, lock 64 is included to secure security shield 28 in its closed position wherein security shield 28 will be fully covering and protecting display tray 22 and the merchandise thereon. Shaft 66 is attached to one end of lock 64 on the interior of case 10. Upon movement of lock 64 into its locked position, shaft 66 will move through an aperture 68 at the front of security shield 28. When in this closed and locked position, security shield 28 will fully secure display tray 22 and the merchandise thereon. Spring 70 is located on shaft 66 near aperture 68 and provides the necessary bias to easily open lock 64, allow retraction of shaft 66 from aperture 68 and allow movement of security shield 28.

In use, when a store is ready to close for the night, the merchandise positioned on display tray 22 in display case 10 can be covered and secured in a manner discouraging break-through theft. Security shield 28 is moved into position to fully obscure and cover display tray 22 as shown in FIGS. 3, 6, and 7 through movement of handle 58 downward. Lock 64 is then actuated to move shaft 66 through aperture 68 and into security shield 28 locking the security shield in its closed position over display tray 22 and the merchandise thereon. In addition, lock 52 is actuated to fully secure rear doors 26. In such a condition, display case 10 is fully locked with all merchandise being fully covered and protect. Breaking transparent top 18 or transparent front 20 will only provide access to the top of security shield 28 but since security shield 28 is locked over display tray 22 and the merchandise thereon, no access is provided to the merchandise itself which remains fully protected and secure from theft. Security shield 28 is positioned over display tray 22, display shelf 24 and all the merchandise in case 10 and is designed to withstand assault by hammering and prying after glass break-through to prevent burglary for up to 10 minutes. This is the time element normally required for average burglar alarm systems to activate and police to arrive.

During business hours, security shield 28 can be unlocked and pulled down to its fully opened and concealed position below display shelf 24. This fully open position provides full view of display tray 22, display shelf 24 and all merchandise in case 10 as illustrated in FIG. 1 of the drawings.

It may be appreciated that security shield 28 may be operated electrically. Such configuration may include a motor, actuator, linear actuator, rotary actuator, wheel drive or the like. With each such configuration, operating elements may include linkages, limit switches, street eyes, positioning markers, positioning lights and the like to provide position information and to control the range of movement and position of security shield 28. Such construction would automate the opening and closing of security shield 28 such that upon actuation of a switch energizing the motor, security shield 28 would move from a closed to open or open to closed position. This would allow show room personnel to unlock all of the cases in a first serial batch operation; then in a second serial batch operation actuate a switch to engage the motor of each case to open the show room for business. The same switch actuation would occur at closing, allowing show room personnel to execute a serial batch operation to close security shield 28 in each case in sequence then execute a second serial batch operation to lock each case, closing the show room to complete the business day. In addition, a foot pedal may be provided to actuate a motor as described above to electronically position security shield 28.

Although we have described our invention with considerable details in the specification, it is to be understood that we may make modifications in the design and changes in the structure as necessary for a specific installation or specific design requirements.

What is claimed is:

1. A theft-resistant display case comprising:
a housing that includes a display section, a display shelf and an exterior wall that is at least partly transparent;
a semi-circular shield movably mounted within said housing for covering the display shelf;
means for selectively moving said semi-circular shield into a first position in said housing, wherein items supported on said display shelf are displayed in said upper section of said housing, and selectively moving said semi-circular shield into a second position in said housing, wherein said display shelf is hidden from view.

2. The theft-resistant display case of claim 1 wherein said semi-circular shield is one piece.

3. The theft-resistant display case of claim 1 wherein said semi-circular shield is pivotable from said first position in said housing into said second position in said housing.

4. The theft-resistant display case of claim 1 including a lock to secure said semi-circular shield in a locked position.

5. The theft-resistant display case of claim 4 wherein the lock secures said semi-circular shield in said second position in said housing wherein the display shelf is hidden from view.

6. The theft-resistant display case of claim 1 including a handle to move said semi-circular shield.

7. The theft-resistant display case of claim 6 wherein said handle is removable.

8. The theft-resistant display case of claim 6 wherein said handle is retractable into said housing.

9. The theft-resistant display case of claim 6 wherein said handle is telescopic.

10. The theft-resistant display case of claim 1 including a foot pedal to move said semi-circular shield.

11. The theft-resistant display case of claim 1 wherein said means for selectively moving said semi-circular shield includes an electric motor.

12. The theft-resistant display case of claim 11 including an electric eye to provide information communicating the position of said semi-circular shield.

13. A display case comprising:
a transparent top, a front panel, a pair of side panels, and a display shelf attached to the said panels below said transparent top;
a shield pivotally mounted within the display case for covering said display shelf;
means for selectively pivoting said shield into a first position in said housing, wherein items supported on said display shelf are displayed in an upper section of said housing, and selectively pivoting said semi-circular shield into a second position in said housing, wherein items supported on said display shelf are hidden from view.
